(19) United States
(12) Patent Application Publication
(10) Pub. No.: US 2015/0226996 A1
(43) Pub. Date: Aug. 13, 2015

(54) DISPLAY APPARATUS AND TELEVISION RECEIVER

(71) Applicant: Sharp Kabushiki Kaisha, Osaka (JP)

(72) Inventor: Mamoru Ohashi, Osaka (JP)

(73) Assignee: SHARP KABUSHIKI KAISHA, Osaka (JP)

(21) Appl. No.: 14/423,357

(22) PCT Filed: Aug. 23, 2013
(86) PCT No.: PCT/JP2013/072519

§ 371 Date: Feb. 23, 2015

(30) Foreign Application Priority Data
Aug. 31, 2012 (JP) 2012-191313

(51) Int. Cl. G02F 1/1333; H04N 5/44; F21V 8/00

(52) U.S. Cl. CPC G02F 1/133308; G02B 6/0011; H04N 5/44; G02F 2001/133317; G02F 2001/133314

(57) ABSTRACT

A liquid crystal display device includes: an LED; an LED substrate having the LED disposed on a plate surface thereof; a liquid crystal panel that uses light from the LED to perform display; a light guide plate having a front face that is a light exiting surface, a back face that is a reverse surface, and two side faces that are light receiving faces; a chassis disposed on the reverse surface side of the light guide plate; a frame disposed on a display surface side of the liquid crystal panel; and a clamping member that holds the LED substrate, that sandwiches a periphery of the light guide plate, the periphery being located beside the light receiving face in the thickness direction of the light guide plate, and that covers at least the liquid crystal panel side of the LED. The clamping member, by being supported at least by the frame, aligns the light guide plate against the frame in the direction of the plate surface of the light guide plate.

### TECHNICAL FIELD

The present invention relates to a display device and to a television receiver.

### BACKGROUND ART

Liquid crystal display device such as liquid crystal televisions, for example, need a separate backlight device as the illumination device, because their display panels, which are liquid crystal panels, do not emit light by themselves. Backlight devices of this kind of liquid crystal display devices are roughly classified into a direct-lit type and an edge-lit type. The edge-lit type backlight devices are considered desirable for further slimming of liquid crystal display devices.

A known configuration for the liquid crystal display devices equipped with an edge-lit type backlight device is the following: notch-like recesses (or protrusions) are provided on edge surfaces of the light guide plate, and protrusions (or recesses) are provided at locations that are a part of the housing and that correspond to the locations of the recesses (or the protrusions). By making the recesses and the protrusions engage, within the housing, the light guide plate is aligned in the direction of its plate surface. Liquid crystal display devices having such a light guide plate alignment configuration are disclosed, for example, in Patent Document 1.

### RELATED ART DOCUMENT

### Patent Document

Patent Document 1: Japanese Patent Application Laid-Open Publication No. 2004-296193

### PROBLEMS TO BE SOLVED BY THE INVENTION

In recent years, for manufacturing cost reduction and to meet demands for further slimmed-down designs, discontinuation of the synthetic resin cabinet, which is an exterior part of liquid crystal display units, is being considered. However, for liquid crystal display devices that do not have such a cabinet, the light guide plate alignment configuration described above can allow light leaking through the spaces between the recesses and protrusions to enter inside through the edge surface of the liquid crystal panel. In this case, excessively bright areas (bright spots) can appear on the display surface of the liquid crystal panel, lowering the visibility of the display surface.

### SUMMARY OF THE INVENTION

The technologies disclosed in this specification were devised in consideration of the problem described above. This specification aims at providing technologies that realize a configuration that aligns the light guide plate in the direction of its plate surface, but at the same time, prevents light emitted from the light source from entering inside through the edge surface of the display panel.

### MEANS FOR SOLVING THE PROBLEMS

The technology disclosed in this specification relates to a display device that includes: a light source; a light source substrate having the light source on one surface thereof; a display panel that uses light from the light source to perform display; a light guide plate having one surface as a light exiting surface, another plate surface as an opposite surface that is opposite to the light exiting surface, and at least one light receiving face on a side, the light guide plate being disposed such that the light exiting surface faces a side of the display panel opposite to a display surface thereof and such that the light receiving face faces the light source so as to guide light from the light source towards the display panel; a chassis disposed on an opposite surface side of the light guide plate; a frame having a frame-like shape disposed on a display surface side of the display panel and sandwiching, together with the chassis, at least the display panel, the light source, and the light guide plate therebetween; and a clamping member that holds the light source substrate, clamps an edge of the light guide plate on a light receiving face side thereof, and covers at least a display panel of the light source, the clamping member being supported by at least the frame so as to fix a position of the light guide plate with respect to the frame.

According to the display device described above, in the manufacturing process, the light source substrate with the light source disposed thereon is attached to the clamping member. After this, periphery of the light guide plate, the periphery being located beside the light receiving face, is sandwiched by the clamping member, by which the sandwich member is attached to the light guide plate. Then, the clamping member sandwiching the light guide plate is disposed to be supported against the frame. The light guide plate can then be aligned against the frame in the direction of its plate surface. Thus, without the need to provide recesses or protrusions on the edge surface of the light guide plate, the light guide plate can be aligned by an alignment member in the direction of its plate surface. Furthermore, because the clamping member is configured to cover the display panel side of the light source, the light emitted from the light source and then guided toward the display panel is blocked by the clamping member. As a result, a configuration that aligns the light guide plate in the direction of its plate surface is realized, yet light emitted from the light source can be prevented from entering inside through the edge surface of the display panel.

The clamping member may be able to be divided into two members in a thickness direction of the light guide plate, the clamping member being constituted of a frame-side member facing the frame and a chassis-side member facing the chassis.

According to this configuration, if, for example, the light source stops emitting light after the light source substrate is attached to the clamping member, the light source can easily be replaced, because the clamping member is divisible into two. This configuration can thus improve the efficiency of works such as parts replacement. Furthermore, because the clamping member is divisible into two, work efficiency when assembling a large display device can also be improved.

The display device may further include a locking piece disposed on either one of the frame-side member or the chassis-side member and protruding towards the other of the frame-side member or the chassis-side member; and a locking hole in the other of the frame-side member or the chassis-side member at a location facing the engaging piece, the locking hole opening towards the locking piece, wherein the locking piece engages the locking hole to assemble the frame-side member and the chassis-side member.

As described above, according to the configuration in which the frame side member and the chassis side member are assembled to each other when the locking piece is caught by the locking hole, the frame side member and the chassis side member can easily be assembled, and the assembled frame side member and the chassis side member can be hard to be separated.

The light receiving face may have a rectangular shape with a short side direction thereof being the thickness direction of the light guide plate, and the clamping member may be able to be further divided along a long side direction of the light receiving face.

According to this configuration, the clamping member is divisible into four. As a result, efficiency in works such as parts replacement and assembly of a large display device can further be improved.

The display device may further include a spring member at a connecting point of the frame-side member and the chassis-side member, the spring member respectively actuating the frame-side member and the chassis-side member to assemble the frame-side member and the chassis-side member.

According to this configuration, the clamping member can be divided into two members: the frame side member and the chassis side member, while these members still stay connected to each other by the spring member. As a result, in the manufacturing process of a liquid crystal display device, the frame side member and the chassis side member can easily be engaged and disengaged.

The light receiving face may have a rectangular shape with a short side direction thereof being a thickness direction of the light guide plate, and protrusions that protrude towards the light guide plate may be provided on the clamping member at respective locations where the light guide plate is clamped, the protrusions extending along a long side direction of the light receiving face, and grooves may be provided in the light receiving face of the light guide plate on both long side directions thereof and have a trench-like shape along the long side directions, the grooves being provided in the light guide plate at locations facing the protrusions and being able to engage the protrusions.

According to this configuration, the clamping member can easily be attached to the light guide plate by engaging the protrusions with the groove section from the opening of the groove section, and then by sliding the light guide plate along the direction in which the protrusion extends or by sliding the clamping member along the direction in which the groove section extends.

The display device may further include a buffer member between the clamping member and the light guide plate at a location where the light guide plate is clamped, the buffer member being softer than the clamping member.

Because the clamping member sandwiches the light guide plate, when a pressure is applied on the light exiting surface and the reverse surface of the light guide plate, a squeaking sound and the like can be generated. According to the configuration described above, because the pressure applied from the clamping member onto the light exiting surface and onto the reverse surface of the light guide plate can be reduced by the buffer member, the squeaking sound and the like can be suppressed.

The clamping member may be secured to the chassis with screws.

According to this configuration, because the clamping member can be secured to the chassis by tightening screws, it is possible to make it hard for the clamping member to be misaligned not only against the frame but also against the chassis.

The clamping member may be a metal having a thermal conductivity that is at least the same as that of the chassis, and the clamping member may include a portion covering a chassis side of the light source, the portion abutting the chassis.

According to this configuration, heat generated near the light source is effectively dissipated from the light source substrate to the chassis side through the clamping member, which is made of a metal. As a result, good thermal dissipation can be obtained.

The display device may further include a support rib provided on the frame at a location exposed to the clamping member, the support rib extending towards the clamping member, and a fitting recess may be provided in the clamping member at a location facing the support rib, the fitting recess being able to engage the support rib.

According to this configuration, a leading end portion of the support rib engages the fitting recess, and therefore the clamping member is supported against the frame. Consequently, a specific configuration that makes the clamping member to be supported against the frame can be realized.

The support ribs may be provided along the edge of the light exiting surface on a light receiving face side with gaps therebetween.

According to this configuration, if flexible substrates or the like are attached to the periphery of the display panel, flexible substrates can be disposed between the support ribs that are intermittently disposed, so that the support ribs and the flexible substrates do not interfere each other. Thus, in the case that other members are disposed near the support ribs, it is possible to make it hard for the other members and the support ribs to interfere each other.

The clamping member may have a projection that protrudes toward the light source at a location exposed to the light source and an abutting surface that abuts a surface of the light source substrate opposite to the one surface on which the light source is disposed, and the light source substrate may be held by being clamped by the projection and the abutting surface in a thickness direction of the light source substrate.

According to this configuration, the light source substrate can easily be held against the clamping member by placing the light source substrate between the abutting surface and the projection, and sliding the light source substrate along the direction in which the abutting surface and the projection extend.

A portion of the projection opposite to a side abutting the light source substrate may be located closer to the light receiving face than a light emitting surface of the light source.

According to this configuration, if the light receiving face of the light guide plate moves toward the light source due to causes such as thermal expansion, the light receiving face touches the projection before it touches the light source. As a result, the light-emitting surface of the light source can be prevented from being damaged or the like by contact of the light receiving face with the light source.

According to the technologies disclosed in this specification, a display device where the display panel described above is a liquid crystal panel using liquid crystals is novel and useful. Also, a television receiver including the display device described above is novel and useful.

### EFFECTS OF THE INVENTION

According to the technologies disclosed in this specification, a configuration that aligns the light guide plate in the direction of its plate surface is realized, but at the same time, light emitted from a light source can be prevented from entering inside through the edge surface of a display panel.

### BRIEF DESCRIPTION OF THE DRAWINGS

FIG. 1 is an exploded perspective view schematically showing the configurations of a television receiver TV and a liquid crystal display unit LDU of Embodiment 1.

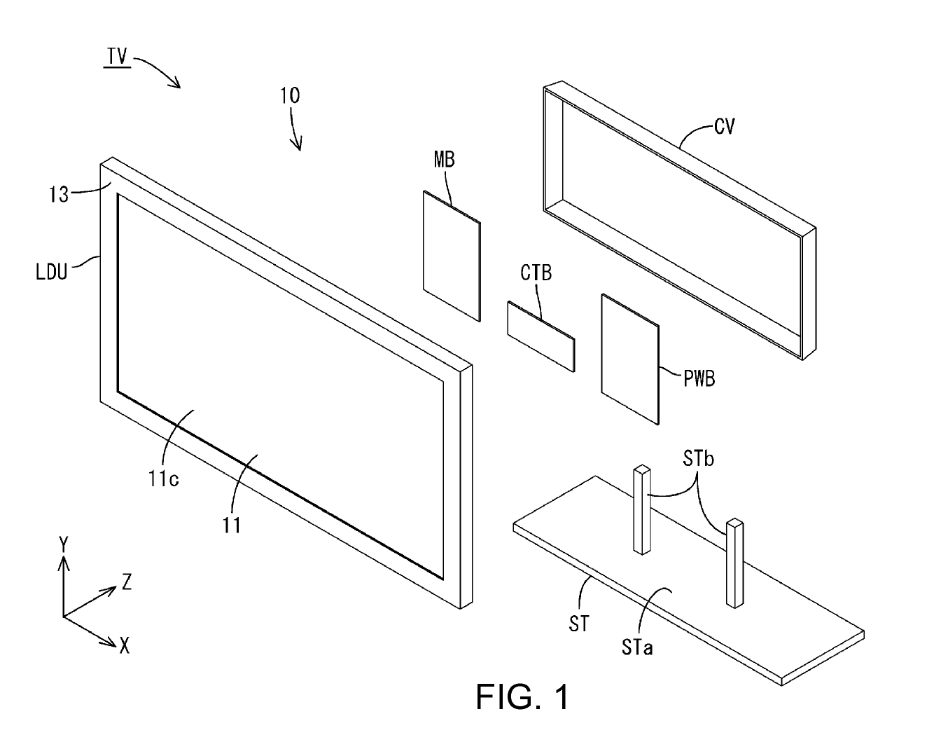

FIG. 2 is a rear view of a television receiver TV and a liquid crystal display device 10.

FIG. 3 is an exploded perspective view schematically showing a liquid crystal display unit LDU included in the liquid crystal display device 10.

FIG. 4 is a cross-sectional view of the liquid crystal display device 10, showing the configuration of the cross section taken along the short side direction.

FIG. 5 is a cross-sectional view of a portion of FIG. 4, showing an enlarged cross-sectional view of the area around one of the clamping members 30.

FIG. 6 is a plan view showing a light guide plate 16 and a unified unit UU disposed over a chassis 14, observed from the front side.

FIG. 7 is a plan view showing the light guide plate 16 and the unified unit UU aligned against a frame 13, observed from the back side.

FIG. 8 is an exploded perspective view schematically showing the configuration of a clamping member 30 that is divided into two: the front side and the back side.

FIG. 9 is an enlarged cross-sectional view of a locking piece 32d and a locking hole 31d of a clamping member 30 that is divided into two: the front side and the back side.

FIG. 10 is a cross-sectional view showing a form of assembling the liquid crystal display device 10.

FIG. 11 is an enlarged cross-sectional view showing the vicinity of one of the clamping member 30 of Modification Example 1 of Embodiment 1.

FIG. 12 is an exploded perspective view schematically showing a clamping member 30 of Modification Example 2 of Embodiment 1, where the clamping member 30 is divided into four: front side and back side, and right side and left side.

FIG. 13 is a cross-sectional view showing a clamping member 130 and the vicinity of one of the light receiving faces 116b of the light guide plate 116 of Embodiment 2.

FIG. 14 is an enlarged cross-sectional view showing the vicinity of one of the clamping members 130.

FIG. 15 is a perspective view showing a front side member 131 and a back side member 132 of the clamping member 130 when they are open.

FIG. 16 is a cross-sectional view showing a clamping member 130 and the vicinity of one of light receiving faces 116b of a light guide plate 116 according to the modification example of Embodiment 2.

FIG. 17 is a cross-sectional view showing a clamping member 230 and the vicinity of one of light receiving faces 216b of a light guide plate 216 of Embodiment 3.

FIG. 18 is an exploded perspective view schematically showing a form of assembling a light guide plate 216 and an LED substrate 218 to a clamping member 230.

### DETAILED DESCRIPTION OF EMBODIMENTS

### Embodiment 1

Embodiment 1 is described with reference to figures. In this embodiment, a liquid crystal display device 10 is shown as an example. In some figures, X, Y, and Z axes are shown. Each of the axes indicates the same direction throughout the figures. The direction of Y axis matches the vertical direction, and the direction of X axis matches the horizontal direction. Unless otherwise stated, up and down positions are described based on the vertical direction.

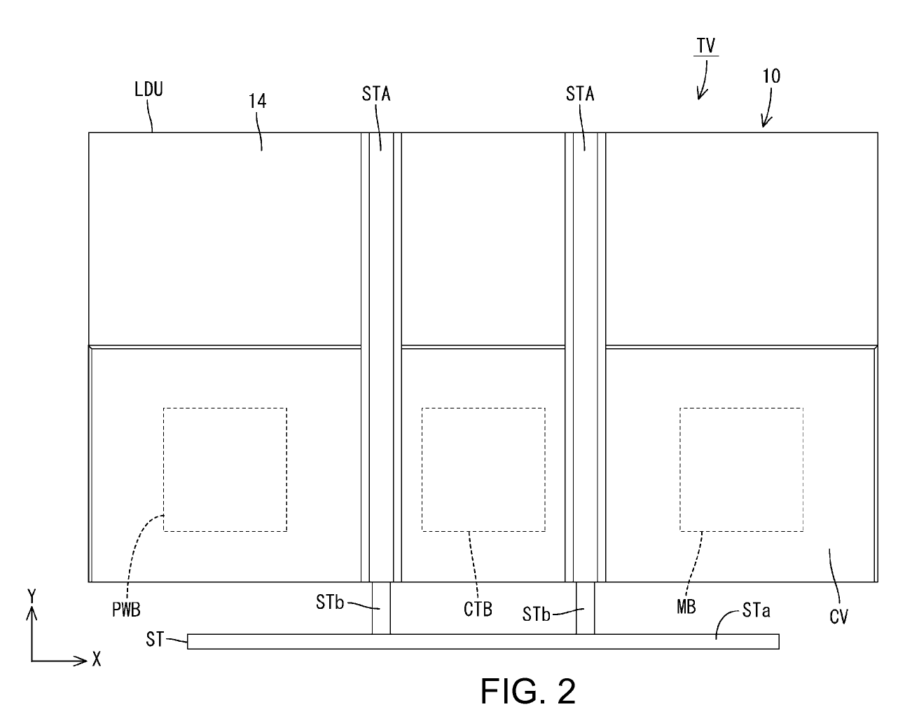

A television receiver TV includes a liquid crystal display unit LDU; substrates PWB, MB, and CTB that are attached to the back face side (rear face side) of the liquid crystal display unit LDU; a cover member CV that is installed to the back face side of the liquid crystal display unit LDU such that it covers the substrates PWB, MB, and CTB; and a stand ST. The stand ST holds the liquid crystal display unit LDU such that the display surface of the liquid crystal display unit LDU extends along the vertical direction (Y-axis direction). The liquid crystal display device 10 according to the present embodiment is a television receiver TV configured as described above minus, at least, structures for receiving television signals (a tuner section of the main substrate MB, and the like). As shown in FIG. 2, the liquid crystal display unit LDU is, overall, a horizontally elongated quadrangular shape (long rectangular shape), and includes a liquid crystal panel 11, which is the display panel, and a backlight device 12, which is the external light source. These are held together by a frame 13 and a chassis 14, which are exterior members constituting the exterior of the liquid crystal display device 10. The chassis 14 according to the present embodiment constitutes a part of the exterior member, and also constitutes a part of the backlight device 12.

First, the configuration of the back face side of the liquid crystal display device 10 is described. As shown in FIG. 2, on the back face of the chassis 14, which constitutes the exterior of the back side of the liquid crystal display device 10, a pair of stand installation members STA extending along the direction of Y axis is installed at two locations which are apart in the X axis direction. The cross-sectional shape of these stand installation members STA is approximately the shape of a channel, having an opening on the chassis 14 side. The stand installation members STA are configured such that a pair of supporting column sections STb of the stand ST is inserted within a space provided between the stand installation members STA and the chassis 14. The space within the stand installation member STA is for installing wiring members (electrical wires and the like) connected to an LED substrate 18 included in the backlight device 12. The stand ST is composed of a base section STa that extends parallel to the X axis direction and parallel to the X axis direction, and a pair of supporting column sections STb that extends upward from the base section STa in the Y axis direction. A cover member CV is made of a synthetic resin, extends across the pair of stand installation members STA in the X axis direction, and covers approximately the lower half of the back face of the chassis 14 shown in FIG. 2. A space is provided between the cover member CV and the chassis 14, to accommodate parts such as various types of substrates PWB, MB, CTB, and the like described below.

As shown in FIG. 2, various types of substrates PWB, MB, and CTB may be, for example, a power supply substrate PWB, a main substrate MB, and a control substrate CTB. It can be the that the power supply substrate PWB is the source of power supply for the liquid crystal display device 10, and can supply driving power to other substrates MB and CTB, and also to an LED 17 and the like included in the backlight device 12. Therefore, it can be said that the power supply substrate PWB doubles as “an LED drive substrate that drives the LED 17.” The main substrate MB includes at least a tuner section that can receive television signals and an image processing section that performs image processing of the television signals received (this and the tuner sections are not shown). The processed image signals can be outputted to a control substrate CTB described below. When the liquid crystal display device 10 is connected to an external image reproduction device (not shown), image signals from the image reproduction device are inputted to the main substrate MB. The image signals, then, are processed in the image processing section, and can be outputted to the control substrate CTB. The control substrate CTB has an ability to convert image signals inputted from the main substrate to liquid crystal drive signals, and to supply the liquid crystal drive signals to the liquid crystal panel 11.

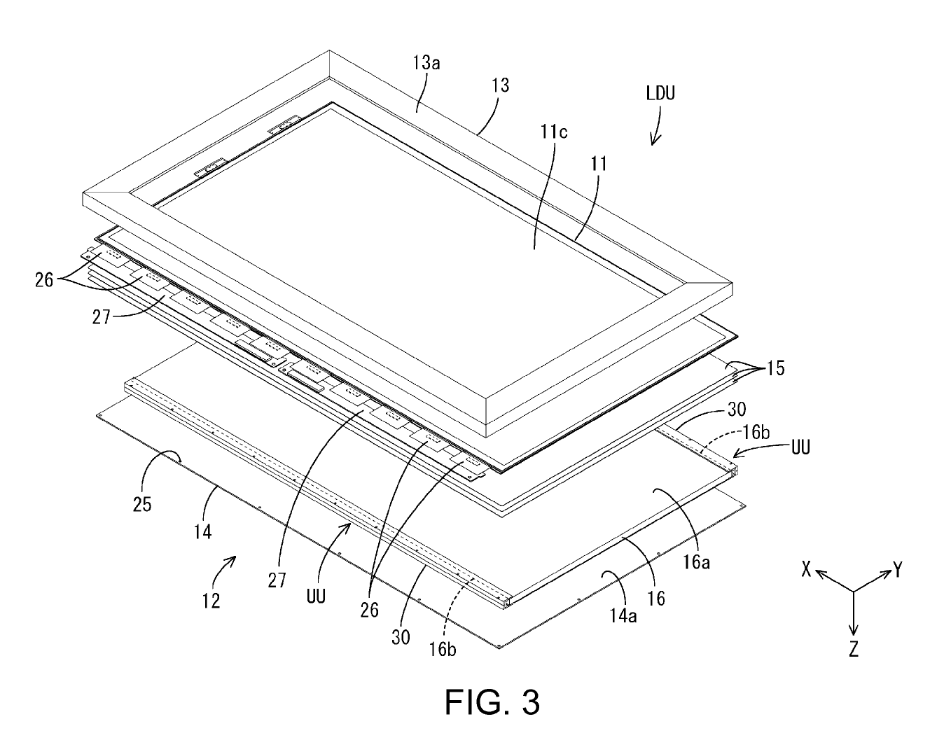

As shown in FIG. 3, a liquid crystal display unit LDU constituting the liquid crystal display device 10 has its main constituting parts enclosed in a space provided between a frame 13 constituting the front side exterior and a chassis 14 constituting the back side exterior. Main constituting parts enclosed between the frame 13 and the chassis 14 include, at least, a liquid crystal panel 11, an optical member 15, a light guide plate 16, and a unified unit UU. Among them, the liquid crystal panel 11, the optical member 15, and the light guide plate 16 are layered on one another, and are held by being sandwiched by the frame 13, which is on the front side, and the chassis 14, which is on the back side. The backlight device 12 is composed of the optical member 15, the light guide plate 16, the unified unit UU, and the chassis 14. This is the configuration of the liquid crystal display unit LDU described above minus the liquid crystal panel 11 and the frame 13. A pair of unified units UU constituting the backlight device 12 is disposed between the frame 13 and the chassis 14 such that the light guide plate 16 is sandwiched by the unified units UU from both sides in the direction of the short side thereof (Y axis direction). The unified unit UU is composed of: LEDs 17, which are the light source; an LED substrate 18 with the LEDs 17 mounted thereon; and a clamping member 30 to which the LED substrate 18 is installed, where a periphery 16e of the light guide plate 16 is held by the clamping member 30, the periphery 16e being located beside a light receiving face 16b of the light guide plate 16. Below, individual constituting parts are described.

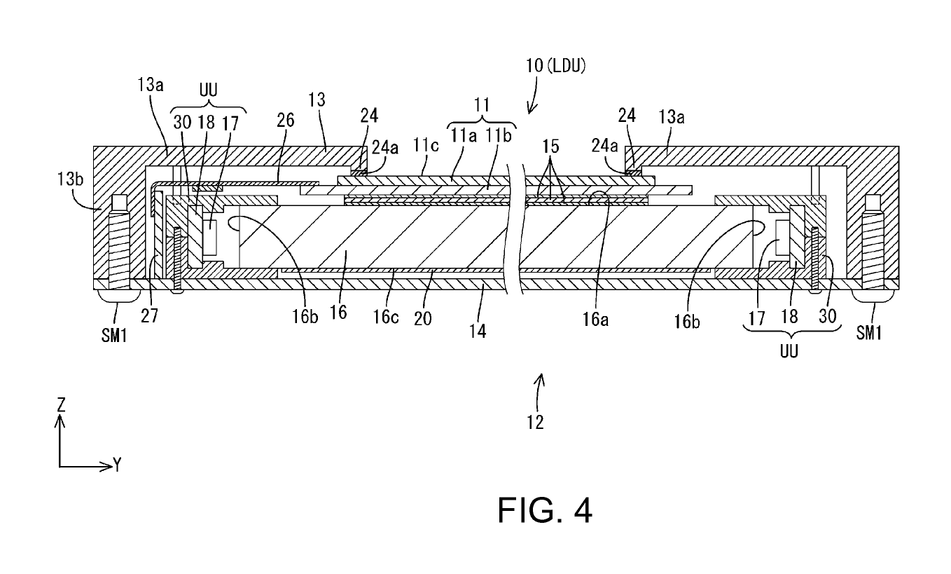

As shown in FIG. 3, the liquid crystal panel 11 has a horizontally elongated quadrangular (long rectangular) shape when observed in a plan view, and is configured to include a pair of highly transparent glass substrates 11a and 11b (see FIG. 4), which are bonded together with a specified gap in between, and to include liquid crystals sealed in between the substrates 11a and 11b. On one of the substrates, which is substrate 11b (array substrate), switching elements (TFT, for example) connected to a source wiring line and a gate wiring line that intersect each other at a right angle, pixel electrodes connected to the switching elements, an alignment film, and the like are provided. On the other substrate, which is substrate 11a (CF substrate), a color filter where segments of different colors such as R (red), G (green) and B (blue) are disposed in a specified arrangement, an opposite electrode, an alignment film, and the like are provided. The liquid crystal panel 11 is disposed in such a manner as being layered on the front side of an optical member 15 described below, where the back side surface of the liquid crystal panel 11 (outside surface of a back side polarizing plate) is in close contact with the optical member 15 with substantially no gaps. This prevents dusts and the like from entering between the liquid crystal panel 11 and the optical member 15. A display surface 11c of the liquid crystal panel 11 is composed of a display area that is located towards the center of the screen and can display images, and a non-display area that is located towards the outer periphery of the display and surrounds the display area (just like a picture frame). To the liquid crystal panel 11, driver components for driving liquid crystals are connected, and a control substrate CTB is also connected via a flexible substrate 26. Based on the signals inputted from the control substrate CTB, images are displayed in the display area of the display surface 11c. Also, a polarizing plate (not shown) is disposed on the outside of both the substrate 11a and substrate 11b.

As shown in FIG. 3, an optical member 15 has, as is the case with the liquid crystal panel 11, a horizontally elongated quadrangular shape when observed in a plan view, and has about the same size (short side dimension and long side dimension) as the liquid crystal panel 11. The optical member 15 is disposed in such a manner as being layered on the front side (light output side) of the light guide plate 16 described below, and is sandwiched by the liquid crystal panel 11 described above and the light guide plate 16. The optical member 15 includes three sheets, and the three sheets are layered on one another. Specifically, the optical member 15 is composed of a diffusion sheet, a lens sheet (prism sheet), and a reflective polarizing sheet disposed in this order from the back side (from the side of the light guide plate 16). The three sheets are about the same size when observed in a plan view.

The light guide plate 16 is made of a synthetic resin material that has a sufficiently higher refractive index than air and is substantially crystal clear (highly transparent), such as an acrylic resin (PMMA, for example) and polycarbonate. As shown in FIG. 3, the light guide plate 16 has, as is the case with the liquid crystal panel 11 and the optical members 15, a horizontally elongated quadrangular shape when observed in a plan view. The light guide plate 16 also has a plate-like shape, having a thickness greater than that of the optical member 15, where the long side direction of the main surface matches the X axis direction, the short side direction matches the Y axis direction, and the plate thickness direction, which intersects the main surface at a right angle, matches the Z axis direction. The light guide plate 16 is layered on the back side of the optical member 15, and is disposed between the optical member 15 and the chassis 14 in such a manner as to be sandwiched by them. As shown in FIG. 4, at least the short side dimension of the light guide plate 16 is greater than the short side dimension of the liquid crystal panel 11 and of the optical members 15, and both edges that are apart along the short side direction (both edges extending along the long side direction) protrude more outwards than such edges of the liquid crystal panel 11 and of the optical member 15 (such that they do not overlap when observed in a plan view). The light guide plate 16 is sandwiched in the Y axis direction by a pair of unified units UU disposed at both sides that are apart along the short side direction, such that light from LED 17 is brought in through both edges located apart along the short side direction. The light guide plate 16 allows the light that is emitted by LED 17 and enters the light guide plate 16 through both ends located apart along the short side direction to propagate inside of the light guide plate 16, and guides it towards the optical member 15 (towards the front side) for emission.

Among the main surfaces of the light guide plate 16, the surface facing the front side (the surface facing the optical members 15) is a light exiting surface 16a from which the light inside the light guide plate is emitted towards the optical member 15 and towards the liquid crystal panel 11. Among outer peripheral edge surfaces located adjacent to the main surfaces of the light guide plate 16, both edge surfaces that are located on the long side, along the X axis direction (both edge surfaces that belong to the pair of edges located apart along the short side direction), are disposed such that they squarely face the corresponding LED 17 (LED substrate 18) with a specified space provided in between. These edge surfaces are a pair of light receiving faces 16b through which light emitted from the LED 17 enters inside. As shown in FIG. 4, on the back side of the light guide plate 16, i.e., on a reverse surface 16c (the surface that faces the chassis 14) located opposite to the light exiting surface 16a, a reflective sheet 20 is provided, covering substantially the entirety of the reverse surface 16c.

The reflective sheet 20 is disposed slightly away from a front face 14a of the chassis 14, but abuts the reverse surface 16c of the light guide plate 16 so that light leaking outside at the back through the reverse surface 16c of the light guide plate 16 can be reflected and be guided back towards the front side. The reflective sheet 20 is made of a synthetic resin, and the color of its surface is white, which is a highly light reflective color. The short side dimension of the reflective sheet 20 is smaller than the short side dimension of the light guide plate 16.

Next, configurations of the LED 17 and the LED substrate 18, which constitute a unified unit UU, are described one by one. The configuration of the clamping member 30, which is another constituting member of the unified unit UU, is described in detail below. The LED 17, which constitutes the unified unit UU, is configured such that LED chips (not shown) are sealed by resin onto a substrate section that is fixed to the LED substrate 18. LED chips mounted on the substrate section emit light with a single emission wavelength, which, specifically, is blue. On the other hand, the resin that seals the LED chips includes a dispersed phosphor substance that emits a specified color when excited by the blue light emitted from the LED chips, producing, overall, approximately white light. For the phosphor substance, any one of, or any appropriate combination of, for example, a yellow phosphor substance that emits yellow light, a green phosphor substance that emits green light, and a red phosphor substance that emits red light can be used. The LED 17 is of a so-called top surface light-emitting type, where the surface of LED 17 that is located opposite to the mounting surface facing the LED substrate 18 (i.e., the surface that squarely faces the light receiving face 16b of the light guide plate 16) is a light-emitting surface 17a.

As shown in FIG. 3, the LED substrate 18, which constitutes the unified unit UU, has a long, narrow plate-like shape and extends along the long side direction of the light guide plate 16 (the X axis direction; the long side direction of the light receiving face 16b). The LED substrate 18 is enclosed by the frame 13 and the chassis 14 such that the plate surface of the LED substrate 18 is parallel to the X axis direction and the Z axis direction, i.e., parallel to the light receiving face 16b of the light guide plate 16. The long side dimension of the LED substrate 18 (X axis direction) is about the same as the long side dimension of the light guide plate 16. The LED 17 configured as described above is mounted on the plate surface of the LED substrate 18 that faces inward, i.e., on the plate surface of the LED substrate 18 that faces the light guide plate 16 (the surface opposing the light guide plate 16). This plate surface is a mounting surface. A plurality of LEDs 17 are disposed in a parallel arrangement on the mounting surface of the LED substrate 18 along the lengthwise direction (X axis direction) of the mounting surface in a row (linearly), with a prescribed space in between. That is, LEDs 17 are disposed on the backlight device 12 with gaps therebetween in a parallel arrangement on both long-side edges of the backlight device 12, along the long side direction. Spaces provided between LEDs 17 disposed adjacent to each other in the direction of X axis, i.e., the arrangement pitch of LEDs 17, are approximately consistent. The direction in which LEDs 17 are arranged matches the long side direction of the LED substrate 18 (X axis direction). On the mounting surface of the LED substrate 18, a wiring pattern (not shown) made of a metal film (copper foil, for example) that extends along the X axis direction and serially connects neighboring LEDs 17 across a group of LEDs 17 is formed. Terminal sections formed on both ends of the wiring pattern are connected to a power supply substrate PWB via wiring members such as connectors and electrical wires, so that the drive power is supplied to individual LEDs 17.

Next, configurations of the frame 13 and the chassis 14 that constitute the exterior members and the support members are described. Both the frame 13 and the chassis 14 are made of a metal such as aluminum, and have more mechanical strength (rigidity) and higher thermal conductivity compared to those made of a synthetic resin. As shown in FIG. 3, the frame 13 and the chassis 14 together enclose a pair of unified units UU at both of their edges that are apart along the short side direction thereof (at both edges that extend in the long side direction). Also, the frame 13 and the chassis 14 enclose the liquid crystal panel 11, the optical member 15, and the light guide plate 16, which are disposed in a layering fashion, in such a manner as to sandwich them from the front side and the back side.

As shown in FIG. 3, the frame 13 has, in its entirety, a horizontally elongated frame shape, so that it can surround the display area on the display surface 11c of the liquid crystal panel 11. The frame 13 is constituted of a panel holding section 13a that is disposed parallel to the display surface 11c of the liquid crystal panel 11, and holds the liquid crystal panel 11 down from the front side; and a side wall section 13b that protrudes from the outer peripheral side section of the panel holding section 13a towards the back side. The frame 13 has an approximately L-shaped cross section. The panel holding section 13a has a horizontally elongated frame shape, just like an outer peripheral side section (non-display area, frame section) of the liquid crystal panel 11, and can hold down substantially the entire outer peripheral side section of the liquid crystal panel 11 from the front side. The panel holding section 13a has a width that can cover, when viewed from the front side, the outer peripheral side section of the liquid crystal panel 11, and the outer peripheral side sections of the optical member 15 and of the light guide plate 16, whose outer peripheral side sections are located radially more outwards than the outer peripheral side section of the liquid crystal panel 11, as well as both of the unified units UU. An external surface of the panel holding section 13a, which has the external surface thereof facing the front side (this is the surface opposite to the surface facing the liquid crystal panel 11), is exposed to the front outside of the liquid crystal display device 10, as is the case with the display surface 11c of the liquid crystal panel 11. The external surface constitutes, together with the display surface 11c of the liquid crystal panel 11, the front face of the liquid crystal display device 10. On the other hand, the side wall section 13b is substantially formed into a quadrangular tube shape that protrudes from the outer peripheral side section (more precisely, an outer peripheral edge) of the panel holding section 13a towards the back side. The side wall section 13b can cover the entire peripheries of the following to be enclosed: the liquid crystal panel 11, optical member 15, light guide plate 16, and the unified units UU. It can also cover the substantially entirety of the periphery of the chassis 14, which is on the back side. The exterior surface of the side wall section 13b that extends along the direction of periphery of the liquid crystal display device 10 is exposed to the outside of the direction of the periphery of the liquid crystal display device 10, constituting the top surface, bottom surface and both of the side surfaces of the liquid crystal display device 10.

The frame 13, which is configured as described above and has a frame-like shape, is an assembly of four frame segments for respective sides (for each of the long side sections and for each of the short side sections). More precisely, the frame segments are a pair of long-side frame segments constituting the long side sections of the frame 13 and a pair of short-side frame segments constituting the short side sections of the frame 13 (the frame 13 is composed of the panel holding section 13a and the side wall section 13b).

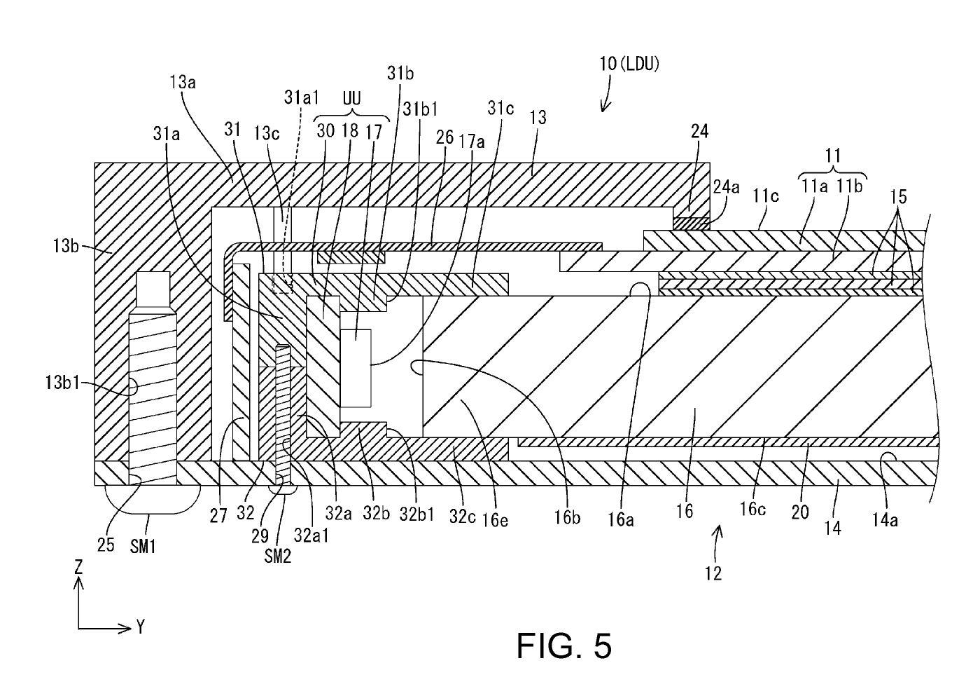

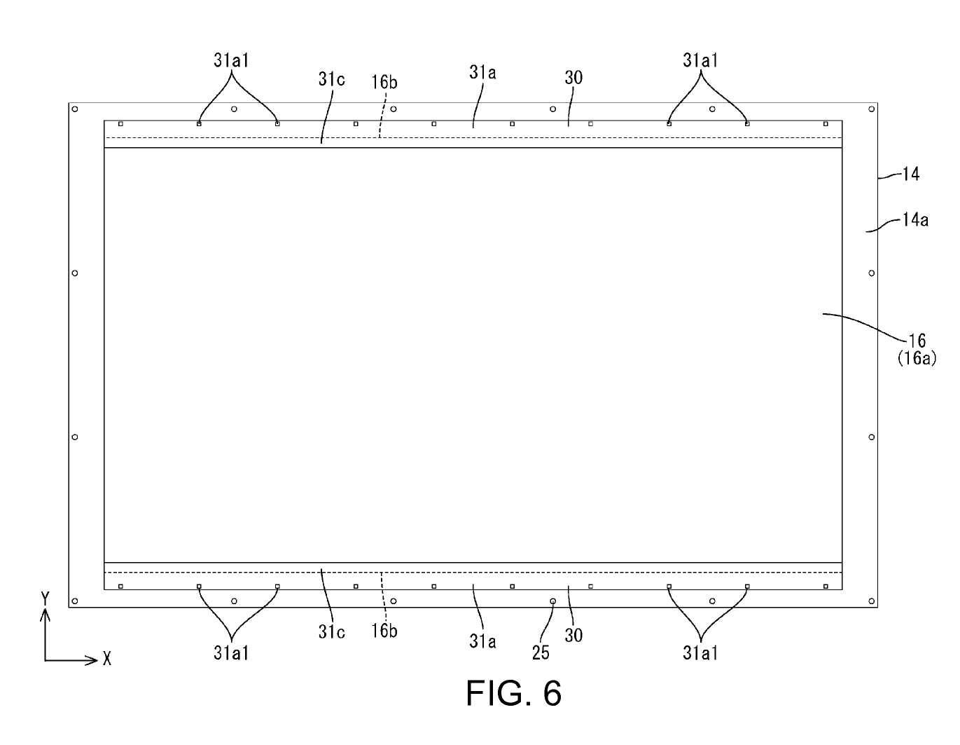

As shown in FIGS. 4 and 5, on the inner edge section of the panel holding section 13a, a holding protrusion 24 that protrudes towards the back side, i.e., towards the liquid crystal panel 11, is integrally formed. The holding protrusion 24 has a buffer member 24a attached to its protruding leading edge surface (see FIG. 6). The holding protrusion 24 can hold the liquid crystal panel 11 down from the front side through the buffer member 24a. For each of the frame segments constituting the frame 13, the buffer member 24a extends along the respective side thereof. A piece of the buffer member 24a is separately provided for each of the sides, and when all the frame segments are assembled together, the buffer member 24a, as a whole, forms a frame that extends along the entire inner periphery of the panel holding section 13a.

Provided at a location that is slightly more inward from the side wall section 13b, but is more outward than a location that, in a plan view, is overlapped by the LED substrate 18, is a support rib 13c extending, in a manner similar to a rib, from the back face of the panel holding section 13a toward the clamping member 30 described below. Support ribs 13c are integrally formed with the panel holding section 13a, and are disposed intermittently along the long side direction of the light guide plate 16 (along the X axis direction). The leading end portion of the support rib 13c engages a fitting recess 31a1 provided in the clamping member 30 (described later), which enables the support rib 13c to support the clamping member 30.

As shown in FIG. 5, the side wall section 13b has a thread groove 13b1 formed therein. The thread groove 13b1 opens out toward the back side, and a first screw member SM1 can be tightened therein. As shown in FIG. 5, a space is provided between the side wall section 13b, which constitutes a long side, and the clamping member 30 described later, to accommodate a printed substrate 27. On the printed substrate 27, a plurality of flexible substrates 26 are arranged intermittently in the long side direction of the printed substrate 27 (in the X axis direction), and the other edges are connected to each other. The support ribs 13c described above extend from the panel holding section 13a toward the clamping member 30, weaving their way through the spaces between intermittently disposed flexible substrates 26. The printed substrate 27 has a connector section thereon, to which one end of the FPC is inserted for connection (the connector section and FPC are not shown). The other end of the FPC is drawn outside from the back side of the chassis 14 through an FPC insertion hole (not shown) formed in the chassis 14, and is connected to the control substrate CTB.

As shown in FIG. 3, the chassis 14 has, just like the light guide plate 16, an overall shape of a horizontally elongated flat plate that can cover substantially the entirety of the light guide plate 16, the unified unit UU, and the like, when viewed from the back side. The front face 14a of the chassis 14 is located to face the reverse surface 16c of the light guide plate 16 and the unified unit UU. On the other hand, the back face of the chassis 14 is exposed to the outside of the back side of the liquid crystal display device 10, and constitutes the rear face of the liquid crystal display device 10. The front face 14a of the chassis 14 is in contact with a part of a back side member 32 of the clamping member 30 described below. The chassis 14 has a plurality of first screw insertion holes 25 in and along its periphery, in which first screw members SM1 are inserted, and a plurality of second screw insertion holes 29 disposed more inwards than the first screw insertion holes 25, in which second screw members SM2 (described below) are inserted.

Next, the configuration of the clamping member 30 that constitutes the unified unit UU, and the form of assembling the clamping member 30, which are the main parts of the present embodiment, are described. As described above, for each of the pair of light receiving faces 16b provided along the long sides of the light guide plate 16, a clamping member 30 is disposed such that it faces the light receiving face 16b. The clamping member 30 is made of a metal having a thermal conductivity that is at least equivalent to that of the chassis 14, and the direction of its long side matches the direction of X axis, and the its long side dimension is about the same as the long side dimension of the LED substrate 18. Also, a portion of the clamping member 30 sandwiches a periphery of the light guide plate 16, the periphery being located beside the light receiving face 16a, in the thickness direction of the light guide plate (Z axis direction). The clamping member 30 is constituted of main sections 31a and 32a, extension sections 31c and 32c, and projections 31b and 32b.

As shown in FIGS. 3 and 5, the main sections 31a and 32a constituting the clamping member 30 are parallel to the plate surface of the LED substrate 18 and to the light receiving face 16b of the light guide plate 16. The main sections 31a and 32a have a greater wall thickness than the LED substrate 18, and the long side direction thereof matches the X axis direction, the short side direction thereof matches the Z axis direction, and the thickness direction thereof matches the Y axis direction. The inside surfaces of the main sections 31a and 32a, i.e., the surfaces facing the light guide plate 16, abut a surface of the LED substrate 18 that is located opposite to the mounting surface of the LED substrate 18 for mounting LEDs 17 thereon. The long side dimensions of the main sections 31a and 32a are approximately the same as the long side dimension of the LED substrate 18, but their short side dimensions are greater than the short side dimension of the LED substrate 18. Furthermore, both end portions of the main sections 31a and 32a, located apart along the short side direction, protrude outwards in the Z axis direction, past both ends of the LED substrate 18. The outside surfaces of the main sections 31a and 32a, i.e., the surfaces opposite to the surfaces that abut against the LED substrate 18, face the side wall section 13b of the frame 13.

As shown in FIGS. 5 to 7, extension sections 31c and 32c that constitute the clamping member 30 have a plate shape which extends parallel to the plate surface of the chassis 14, and the long side direction thereof matches the X axis direction, the its short side direction thereof matches the Y axis direction, and the thickness direction thereof matches the Z axis direction. The extension sections 31c and 32c are both configured to protrude inwards from both end portions of the main sections 31a and 32a located apart along the short side direction thereof (i.e., the end portions that protrude outwards in the direction of Z axis, past both ends of the LED substrate 18) along the Y axis direction, i.e., towards the light guide plate 16. Furthermore, the extension sections 31c and 32c are configured such that inside surfaces of their leading end portions (the surfaces facing the light guide plate 16) abut respectively against the periphery of the light guide plate 16, the periphery being located beside the light receiving face 16b and on the light exiting surface 16a, and against the periphery of the light guide plate 16, the periphery being located beside the light receiving face 16b and on the reverse surface 16c. Thus, the periphery of the light guide plate 16, the periphery being located beside the light receiving face 16b, is sandwiched by the extension sections 31c and 32c in the thickness direction of the light guide plate (Z axis direction). Also, inside surfaces of the extension sections 31c and 32c respectively abut both edges of the LED substrate 18, whose edges are located apart along the direction of short side of the LED substrate 18. The extension sections 31c and 32c extend in the long side direction of the LED substrate 18 (X axis direction), covering the front side and the back side of LEDs 17.

Projections 31b and 32b that constitute the clamping member 30 are each formed on the inside surface of extension sections 31c and 32c (the surface that faces the LED 17). Each protrudes towards the LED 17 from the inside surface along the inside surface up to a point that is located slightly more inwards than the LEDs 17 (closer to the light guide plate 16), and also extends in the X axis direction. The LED substrate 18 is disposed between the main sections 31a and 32a, and the projections 31b and 32b. Because of the presence of the projections 31b and 32b, concave grooves are formed between the main sections 31a and 32a, and the projections 31b and 32b. The concave grooves have a width (the width extends along the Y axis direction) that is approximately the same as the thickness of the LED substrate 18. Therefore, the LED substrate 18 is sandwiched, on both of its edges located apart along the direction of its short side, by the main sections 31a and 32a, and the projections 31b and 32b in the thickness direction of the LED substrate 18 (Y axis direction). Thus, the LED substrate 18 is held between the main sections 31a and 32a, and the projections 31b and 32b. Surfaces 31b1 and 32b1 of the projections 31b and 32b, whose surfaces are opposite to the surfaces of the projections 31b and 32b that face the LED substrate 18, are located closer to the light receiving face 16b than the light-emitting surface 17a of the LED 17 is located to the light receiving face 16b.

The clamping member 30 can be divided into two: a front side member (an example of the frame side member) 31 and a back side member (an example of the chassis side member) 32. More precisely, the main sections 31a and 32a of the clamping member 30 can be separated from each other apart in the short side direction thereof (Z axis direction). Therefore, the front side member 31 and the back side member 32 have a similar shape. That is, the front side member 31 is constituted of a front side main section 31a, a front side extension section 31c that extends from the front side main section 31a toward the light exiting surface 16a of the light guide plate 16, and a front side projection 31b that extends from the front side extension section 31c toward the LED 17. Like the front side member 31, the back side member 32 is constituted of a back side main section 32a, a back side extension section 32c that extends from the back side main section 32a toward the reverse surface 16c of the light guide plate 16, and a back side projection 32b that extends from the back side extension section 32c toward the LED 17. A part of the back side main section 32a that faces the chassis 14, and a part of the back side extension section 32c that faces the chassis 14 are entirely in contact with the front face 14a of the chassis 14.

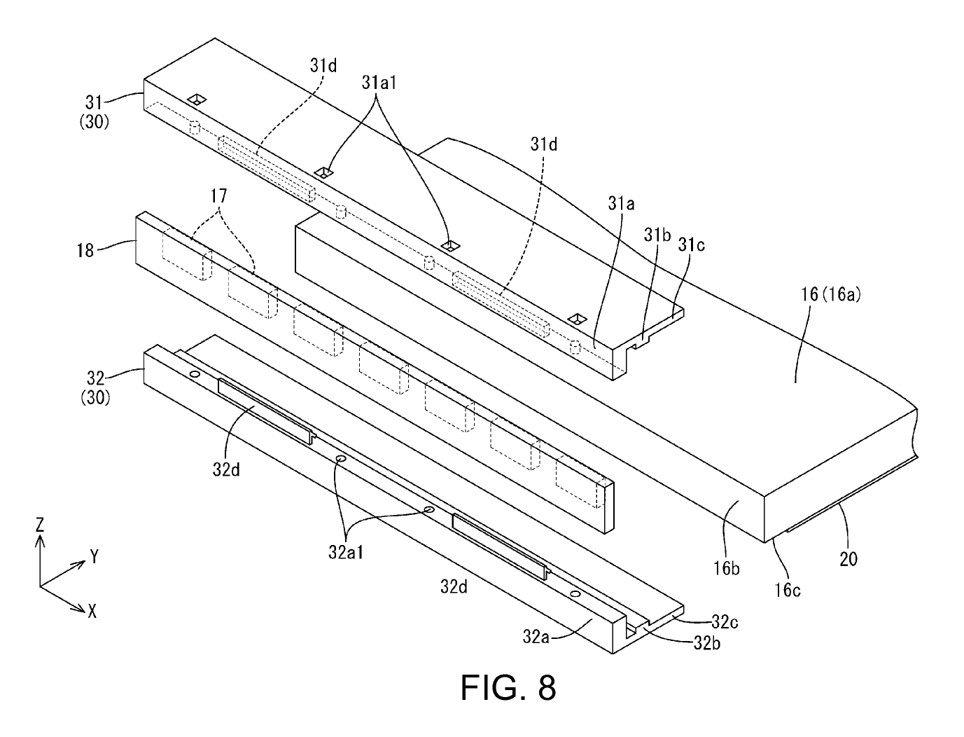

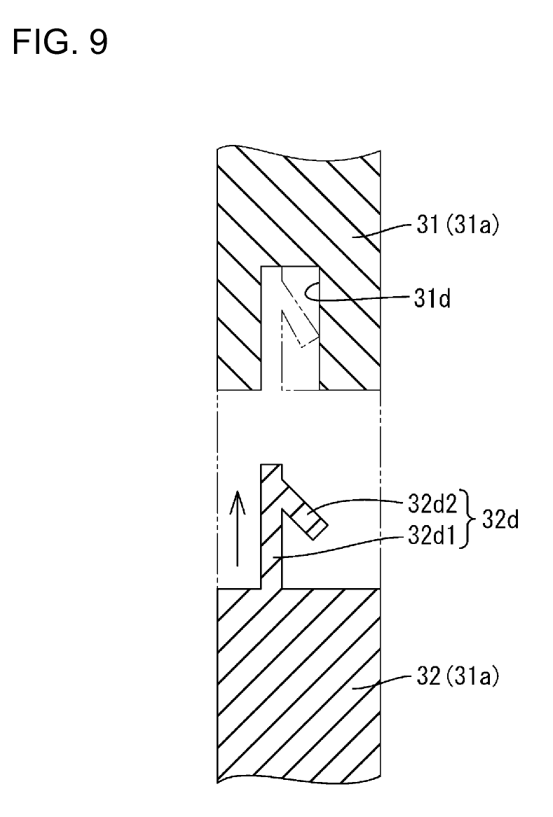

Here, with reference to FIGS. 8 and 9, the form of assembling the front side member 31 and the back side member 32 is described. The clamping member 30 is schematically shown in FIG. 8, which is a simplified representation of the clamping member 30 shown in FIGS. 3, 6, and 7. As shown in FIG. 8, the back side main section 32a of the back side member 32 has a plurality of locking pieces 32d provided thereon, where the locking pieces 32d protrude toward the front side main section 31a of the front side member 31. On the other hand, the front side main section 31a of the front side member 31 has locking holes 31d thereon at locations corresponding to the locking pieces 32d described above. The locking holes 31d open up toward the locking pieces 32d. As shown in FIG. 9, the locking hole 31d is composed of a bottom surface and a side surface, and has a rectangular cross section. As shown in FIG. 9, the locking piece 32d is composed of a main part 32d1 that extends straight up toward the locking hole 31d, and a branch part 32d2 that branches off from the top end of the main part 32d1 toward the back side main section 32a. The branch part 32d2 is made of a material that can deform elastically and is constructed so that it deforms elastically against the main part 32d1. Also, as shown in FIG. 9, the width of the locking piece 32d is slightly greater than the width of the opening of the locking hole 31d.

When engaging the front side member 31 with the back side member 32, by inserting the locking piece 32d of the back side member 32 straight into the locking hole 31d of the front side member 31 as indicated by the two-dot chain line of FIG. 9, the locking piece 32d enters the locking hole 31d. Here, because the branch part 32d2 of the locking piece 32d elastically deforms as it enters the locking hole 31d, the locking piece 32d can be held in place in the locking hole 31d. As a result, the front side member 31 and the back side member 32 can be engaged with each other. Once the locking piece 32d is held in the locking hole 31d, the branch part 32d2 of the locking piece 32d is pressed against the side surface of the locking hole 32d due to elastic return. As a result, the locking piece 32d is hard to be disengaged from the locking hole 31d. Thus, the front side member 31 and the back side member 32 are configured such that they can be easily engaged, but not easily disengaged.

Next, a configuration for supporting the clamping member 30 against the frame 13 and against the chassis 14 is described. As shown in FIG. 6, in a surface of the front side main section 31a of the front side member 31, the surface of which faces the panel holding section 13a of the frame 13, a plurality of fitting recesses 31a1 that can engage the leading end portion of the support ribs 13c extending from the frame 13, which are described above, are provided at locations that correspond to the locations of the support ribs 13c. The fitting recesses 31a1 are provided intermittently along the long side direction of the front side main section 31a (in the X axis direction), at locations corresponding to the locations at which the support ribs 13c are provided. Each of the support ribs 13c provided on the frame 13 has a leading end portion that engages the corresponding fitting recess 31a1 provided in the clamping member 30. Thus, the clamping member 30 is supported against the frame 13. Also, because each of the fitting recesses 31a1 engages the corresponding support rib 13c, the clamping member 30 is aligned against the frame 13 in the long side direction (in the X axis direction) and in the short side direction (in the Y axis direction) of the clamping member 30.

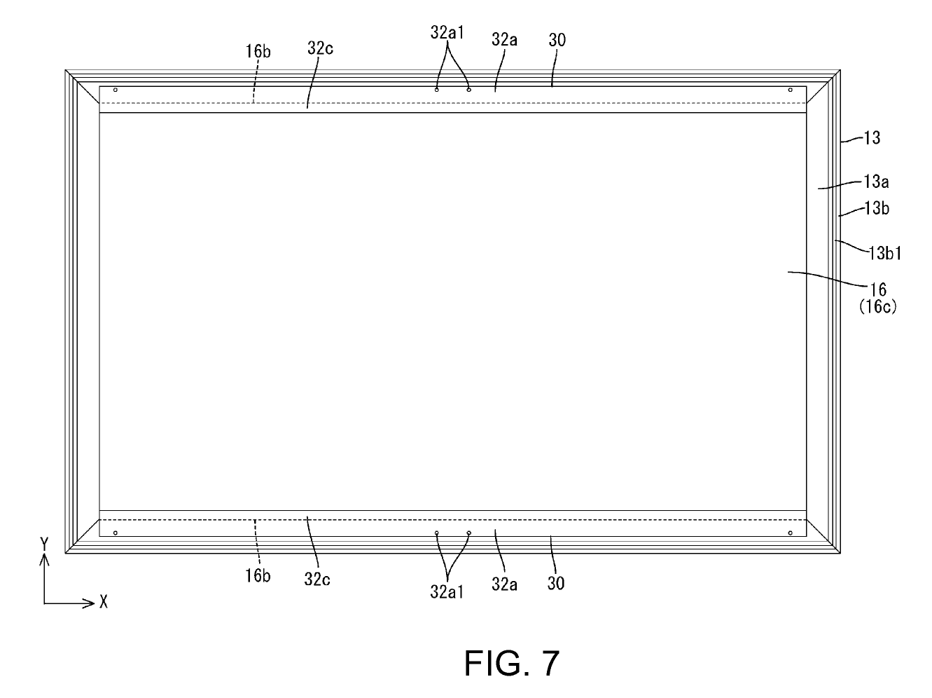

As shown in FIGS. 5 and 7, in a surface of the back side main section 32a of the back side member 32, the surface of which faces the chassis 14, a plurality of screw holes 32a1 that are open toward the chassis 14 are provided, where the deepest point of those holes reaches into the front side main section 32a. The screw holes 32a1 are provided intermittently along the long side direction of the clamping member 30 (the X axis direction) at locations that correspond to the locations of second screw insertion holes 29 provided in the chassis 14 (see FIG. 7). From the back side of the chassis 14, second screw members SM2 are screwed in through the second screw insertion holes 29 and screw holes 32a1 in this order. Thus, the clamping member 30 is supported against the chassis 14. Also, because the back side main section 32 of the clamping member 30 is attached to the chassis 14 with the second screw members SM2, the clamping member 30 is secured to the chassis 14.

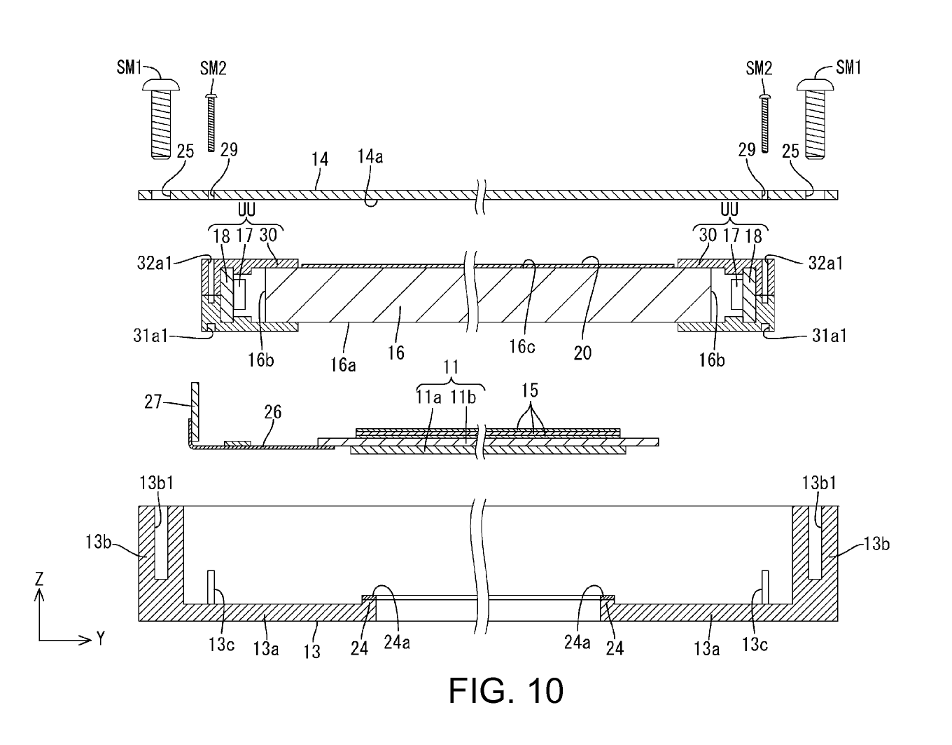

Next, a manufacturing process of the liquid crystal display device 10 is described. In a manufacturing process of the liquid crystal display device 10 according to the present embodiment, the unified unit UU is assembled in advance. That is, between the front side member 31 and the back side member 32 of the clamping member 30, while they are still separate, the LED substrate 18 having LEDs 17 mounted thereon and the periphery of the light guide plate 16, the periphery being located beside the light receiving face 16b, are inserted. The front side member 31 and the back side member 32 are then assembled to complete a unified unit UU. Here, in the manufacturing process of the liquid crystal display device 10, the liquid crystal display device 10 is manufactured by assembling members in order from the front surface side of the liquid crystal display device 10 (from the top side in FIG. 4). Specifically, as shown in FIG. 10, with the front side and the back side of the frame 13 reversed, the liquid crystal panel 11 and the optical member 15 are aligned and placed in this order on the back side of the frame 13. Next, the unified unit UU is aligned in the direction of plate surface of the light guide plate 16 (in the direction of X-Y plane) so that the support ribs 13c provided on the frame 13 correspond to respective fitting recesses 31a1 provided in the clamping member 30. As the support ribs 13c engage the corresponding fitting recesses 31a1, the unified unit UU is enclosed inside the frame 13, on the back side of the frame 13. Next, the chassis 14 is aligned in the direction of the plate surface thereof (in the X-Y plane direction) so that the first thread grooves 13b1 provided in the side wall section 13b of the frame 13 correspond to the first screw insertion holes 25 provided in the chassis 14, and the second thread grooves 32a1 provided in the unified unit UU correspond to the second screw insertion holes 29 provided in the chassis 14. The chassis 14 is then placed over the back side of the frame 13 (on the leading end of the side wall section 13b). Lastly, the first screw members SM1 and the second screw members SM2 are tightened from the back side of the chassis 14. Thus, the unified unit UU is enclosed between the frame 13 and the chassis 14, the chassis 14 is attached to the frame 13, and the chassis 14 is attached to the unified unit UU. Through this manufacturing process, a liquid crystal display device 10 is now complete.

As described above, the clamping member 30 sandwiches the light guide plate 16 in the thickness direction thereof (in the Z axis direction) to hold in place the light guide plate 16 and the LED substrate 18 with the LED 17 mounted thereon. Thus, the light guide plate 16, the LED substrate 18, and the clamping member 30 hold each other to be unified and to form a unified unit UU. Also, the clamping member 30 constituting the unified unit UU is supported by the frame 13 and is secured to the chassis 14, and thereby the unified unit UU is aligned between the frame 13 and the chassis 14. Therefore, in the liquid crystal display device 10 according to the present embodiment, a configuration that can align the light guide plate 16 without the need to provide recesses and protrusions for the light guide plate 16 aligned on the edge surface of the light guide plate 16 is realized.

As described above, in the manufacturing process of the liquid crystal display device 10 according to the present embodiment, the LED substrate 18 having LEDs 17 provided thereon is attached to the clamping member 30, and then the periphery of the light guide plate 16, the periphery being located beside the light receiving face 16b, is sandwiched by the clamping member 30. As a result, the clamping member 30 is attached to the light guide plate 16. The clamping member 30 sandwiching the light guide plate 16 is supported by the support ribs 13c of the frame 13. Thus, the light guide plate 16 can be aligned against the frame 13 in the plate surface direction thereof (in the X-Y plane direction). Therefore, without the need to provide recesses and protrusions on the edge surface of the light guide plate 16, the light guide plate 16 can be aligned in the plate surface thereof (X-Y plane direction) with an alignment member 30. Furthermore, because an upper member 31 of the clamping member 30 is configured to cover the front side of the LED 17 (the side facing the liquid crystal panel 11), the light emitted from the LED 17 toward the liquid crystal panel 11 is blocked by the upper member 31 of the clamping member 30. As a result, a configuration in which the light guide plate 16 can be aligned in the plate surface direction thereof (in the X-Y plane direction) is realized, yet light emitted from the LED 17 can be prevented from entering inside through the edge surface of the liquid crystal panel 11.

In the liquid crystal display device 10 according to the present embodiment, the clamping member 30 is divisible into two members, apart in the thickness direction of the light guide plate 16 (direction of Z axis), whose members constitute the clamping member 30 are: the front side member 31 disposed to face the frame 13, and the back side member 32 disposed to face the chassis 14. According to such a configuration, if, for example, an LED 17 stops emitting light after the LED substrate 18 is attached to the clamping member 30, because the clamping member 30 can be divided into two, the LED 17 can easily be replaced. Thus, this configuration can improve efficiency in work such as parts replacement. Furthermore, because the clamping member 30 is divisible into two, work efficiency when assembling a large liquid crystal display device can also be improved.

Also, a liquid crystal display device 10 according to the present embodiment is configured such that the back side member 32 of the clamping member 30 is attached to the chassis 14 with screws, and is thereby secured to the chassis 14. According to such a configuration, the clamping member 30 can be secured to the chassis 14 by tightening screws, and therefore it is possible to make errors difficult to occur in the alignment of the clamping member 30 against the chassis 14 as well as against the frame 13.

Also, the liquid crystal display device 10 according to the present embodiment includes a clamping member 30 that is made of a metal having at least the same thermal conductivity as the chassis 14, and that has a portion that covers the back side of the LEDs 17 (the side facing the chassis 14), where the portion that covers the side facing the chassis 14 abuts the chassis 14. According to such a configuration, heat generated near the LEDs 17 is dissipated effectively from the LED substrate 18 toward the chassis 14 through the clamping member 30 that is made of a metal, and therefore a good heat dissipation performance can be achieved.

Also, in the liquid crystal display device 10 according to the present embodiment, the clamping member 30 has projections 31b and 32b at locations exposed to the LEDs 17, which has projections protruding toward the LEDs 17. The clamping member 30 also has a surface that abuts a surface of the LED substrate 18, the surface of the LED substrate 18 being located opposite from the surface of the LED substrate 18 on which the LEDs 17 are mounted. The LED substrate 18 is supported by being sandwiched in the thickness direction thereof (Z axis direction) by the surface it abuts against and the projections 31b and 32b. According to such a configuration, by enclosing the LED substrate 18 between the surface it abuts against and the projections 31b and 32b, and by sliding the LED substrate 18 along the direction in which the abutting surface and the projections 31b and 32b extend, the LED substrate 18 can easily be held against the clamping member 30.

In a liquid crystal display device 10 according to the present embodiment, surfaces 31b1 and 32b1 of the projections 31b and 32b, which has surfaces that are opposite from the surfaces abutting against the LED substrate 18, are located closer to the light receiving face 16b than the light-emitting surface 17a of LED 17 is located to the light receiving face 16b.

According to such a configuration, if the light receiving face 16b of the light guide plate 16 moves toward LED 17 due to causes such as thermal expansion, the light receiving face 16b touches the projections 31b and 32b before it touches the LED 17. Consequently, light-emitting surface 17a of the LED 17 can be prevented from being damaged or the like by contact of the light receiving face 16b and the LED 17.

A liquid crystal display device 10 according to the present embodiment is a so-called cabinet-less type liquid crystal display device 110, which no longer includes a synthetic resin cabinet, which is an exterior part of the liquid crystal display unit. A liquid crystal display device 10, which is a cabinet-less type, is configured such that an optical member 15 and a liquid crystal panel 11 are layered on the light exiting surface 16a of the light guide plate 16. Therefore, if recesses and protrusions are provided on the edge surface of the light guide plate 16, light that passes through inside the light guide plate 16 leaks through the recesses and protrusions, and such light can enter inside through the edge surface of the liquid crystal panel 11. If there is any light entering inside through the edge surface of the liquid crystal panel 11, excessively bright areas (bright spots) can appear on the display surface 11c of the liquid crystal panel 11. By contrast, in the liquid crystal display device 10 according to the present embodiment, it is difficult for light to leak through the edge surface of the light guide plate 16, because recesses or protrusions are not provided on the edge surface of the light guide plate 16. Furthermore, because the front side of the LEDs 17 (the side facing the liquid crystal panel 11) is covered by the front side extension section 31c of the clamping member 30, light emitted from the LEDs 17 is prevented from directly proceeding toward the liquid crystal panel 11.

### Modification Example 1 of Embodiment 1

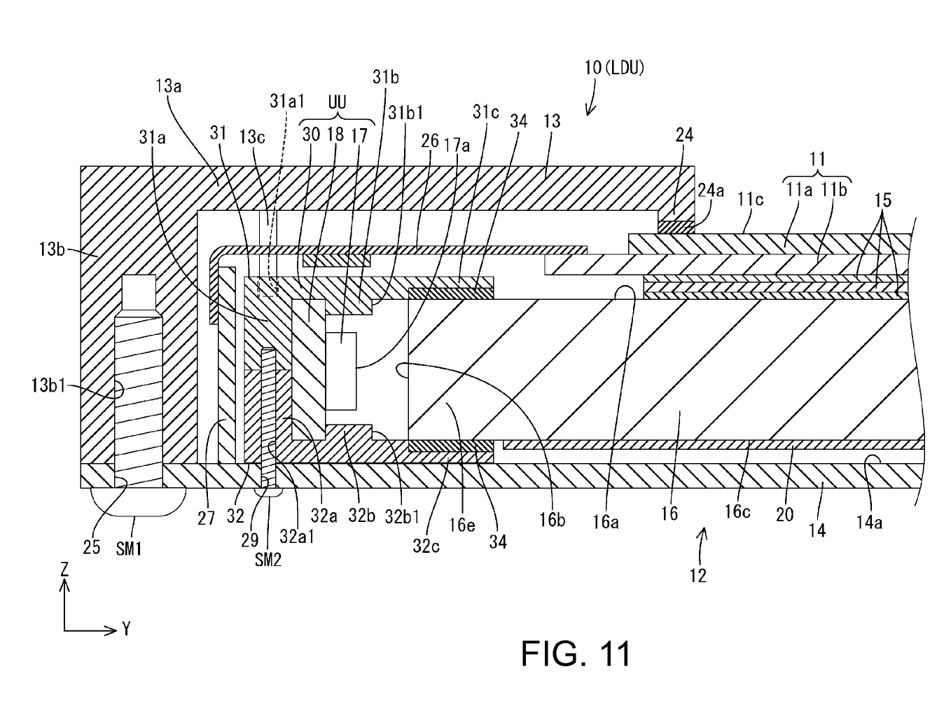

Next, Modification Example 1 of Embodiment 1 is described. A liquid crystal display device 10 according to Modification Example 1 is different from the one according to Embodiment 1 in that it includes a buffer member 34. Other aspects of the configuration are similar to Embodiment 1, and therefore descriptions of the structure, functions, and effects are omitted. As shown in FIG. 11, in Modification Example 1 of Embodiment 1, a buffer member 34 having shock-absorbing characteristics is disposed at locations on the leading end portions of extension sections 31c and 32c constituting a clamping member 30, which has locations respectively facing a light exiting surface 16a and a reverse surface 16c of the light guide plate 16 (locations at which the light guide plate 16 is held), such that the buffer member 34 abuts the light exiting surface 16a and the reverse surface 16c of the light guide plate 16. The buffer member 34 is made of a material that is softer than the clamping member 30. That is, the extension sections 31c and 32c hold the periphery 16e of the light guide plate 16, the periphery being located beside the light receiving face 16b, through the buffer members 34 in the thickness direction of the light guide plate 16 (Z axis direction). Here, because the light guide plate 16 is sandwiched by the clamping member 30, pressure is applied to the light exiting surface 16a and the reverse surface 16c of the light guide plate 30, and as a result, a squeaking sound and the like can be generated. However, in a configuration according to the present embodiment, the pressure applied from the extension sections 31c and 32c of the clamping member 30 onto the light exiting surface 16a and to the reverse surface 16c of the light guide plate 16 is eased by the buffer member 34. As a result, such a squeaking sound and the like can be suppressed.

### Modification Example 2 of Embodiment 1

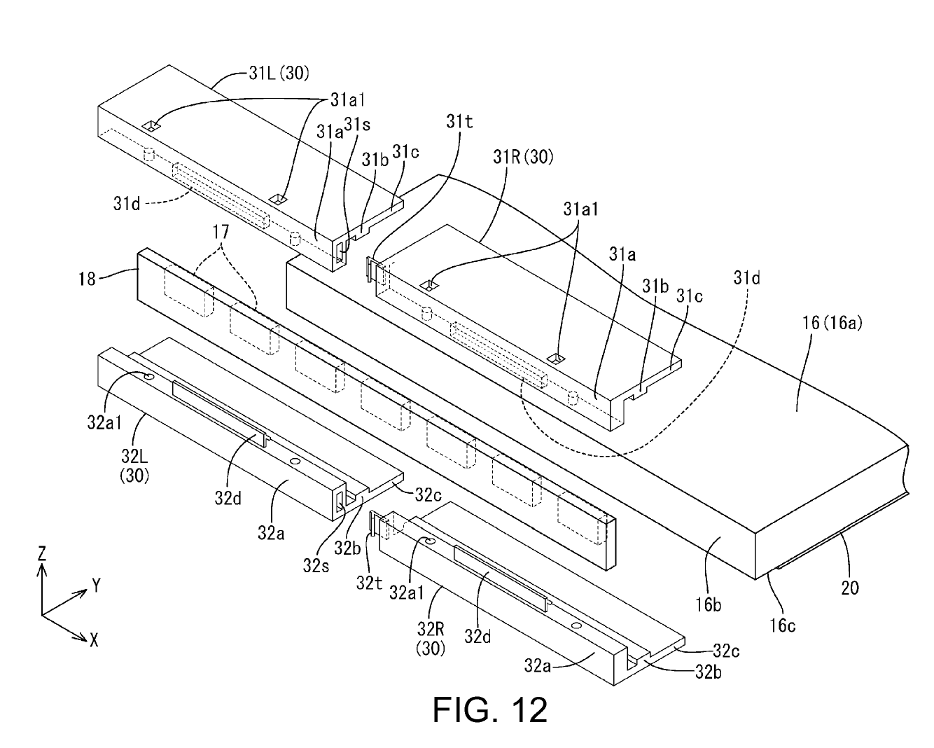

Next, Modification Example 1 of Embodiment 1 is described. A liquid crystal display device 10 according to Modification Example 2 is different from the one according to Embodiment 1 regarding the configuration of the clamping member 30 and the form of assembling the clamping member 30. Other aspects of the configuration are similar to Embodiment 1, and therefore descriptions of the structure, functions, and effects are omitted. As shown in FIG. 12, in Modification Example 2 of Embodiment 1, each of the front side member 31 and the back side member 32 constituting the clamping member 30 can further be divided into two members, apart along the direction of its long side (direction of X axis). That is, the front side member 31 is divisible into a left front side member 31L and a right front side member 31R, and the back side member 32 is divisible into a left back side member 32L and a right back side member 32R. At a location on the right front side member 31R that faces the left front side member 31L, and at a location on the left back side member 32L that faces the right back side member 32R, locking pieces 31t and 32t that protrude respectively toward the left front side member 31L and toward the left back side member 32L are provided. At locations on the left front side member 31L and on the left back side member 32L that correspond to the locking pieces 31t and 32t, locking holes 31s and 32s opening up respectively toward the locking pieces 31t and 32t are provided. The locking pieces 31t and 32t, and the locking holes 31s and 32s have similar shapes as the locking piece 32d and the locking hole 31d that are provided for assembling the front side main section 31a and the back side main section 32a. The only difference is their sizes. As a result, the form of assembling the left front side member 31L and the right front side member 31R, and the form of assembling the left back side member 32L and the right back side member 32R are similar to the form of assembling the front side main section 31a and the back side main section 32a. Therefore, descriptions of them are omitted.

According to the configuration described above, the clamping member 30 can be divided into four pieces, apart in the up/down direction (Z axis direction) and apart in the left/right direction (X axis direction). Here, in the manufacturing process where the liquid crystal display device 10 is used for a super large (90″ type, for example) television receiver TV, if the clamping member 30 is not configured to be divisible into smaller pieces, the clamping member 30 becomes large, and may be difficult to handle during the assembly. In contrast, in the liquid crystal display device 10 according to this modification example, the clamping member 30 is divisible into four pieces. Therefore, in the manufacturing process for a television receiver TV, the clamping member 30 can be assembled efficiently.

### Embodiment 2

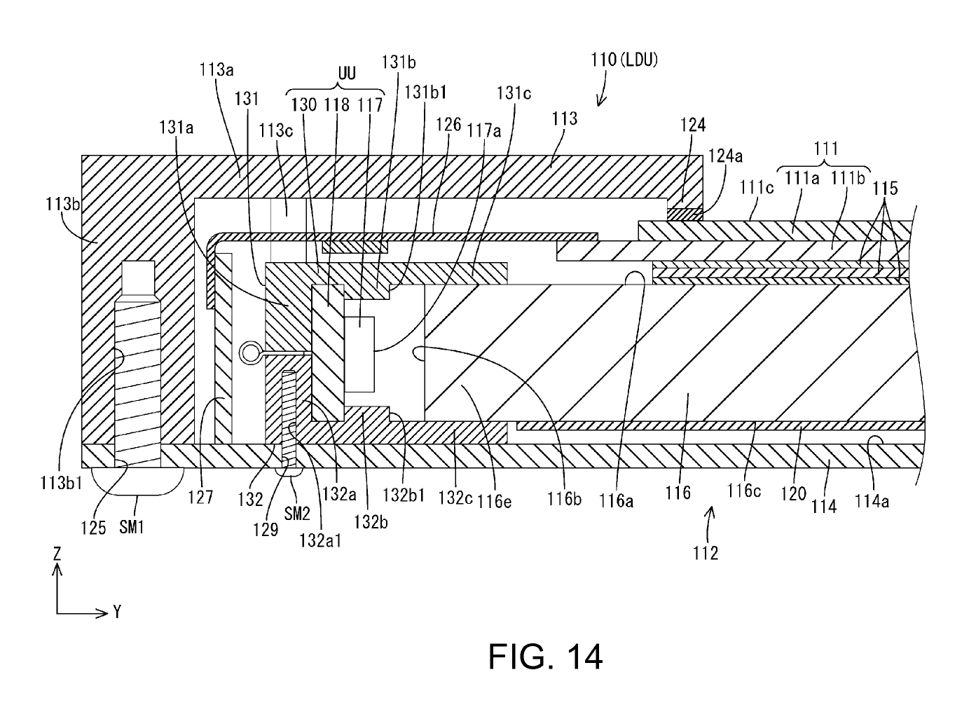

Embodiment 2 is described with reference to figures. In Embodiment 2, the form of assembling a front side member 131 and a back side member 132 that constitute a clamping member 130, and the form of supporting a clamping member 130 against a frame 113 is different from those of Embodiment 1. Other aspects of the configuration are similar to Embodiment 1, and therefore descriptions of the structure, functions, and effects are omitted. In FIG. 14, sites whose reference characters are those used in FIG. 5 plus 100 are identical to the sites described in Embodiment 1.

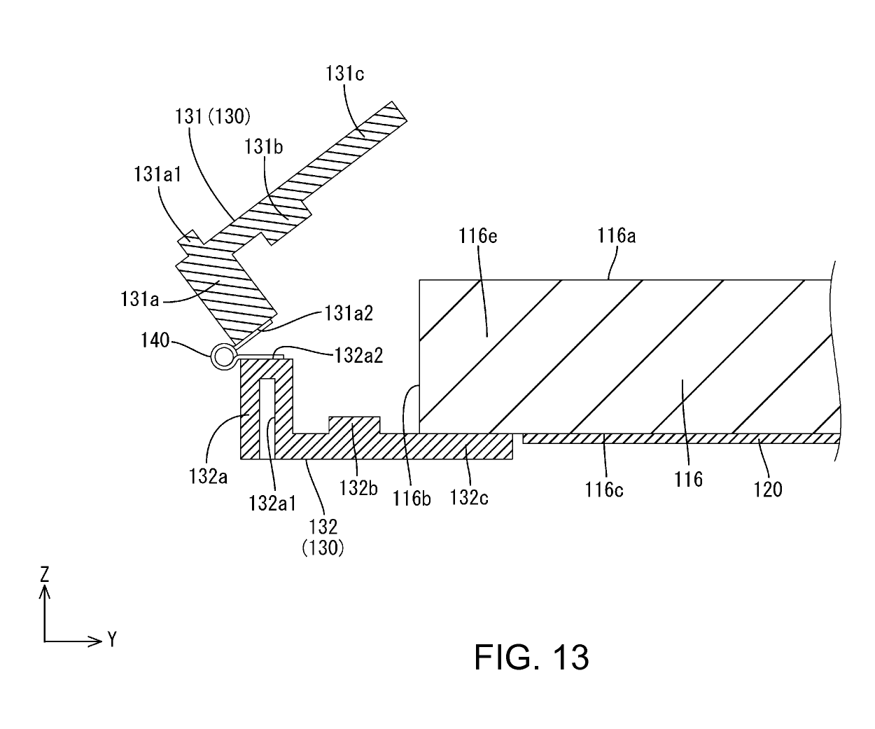

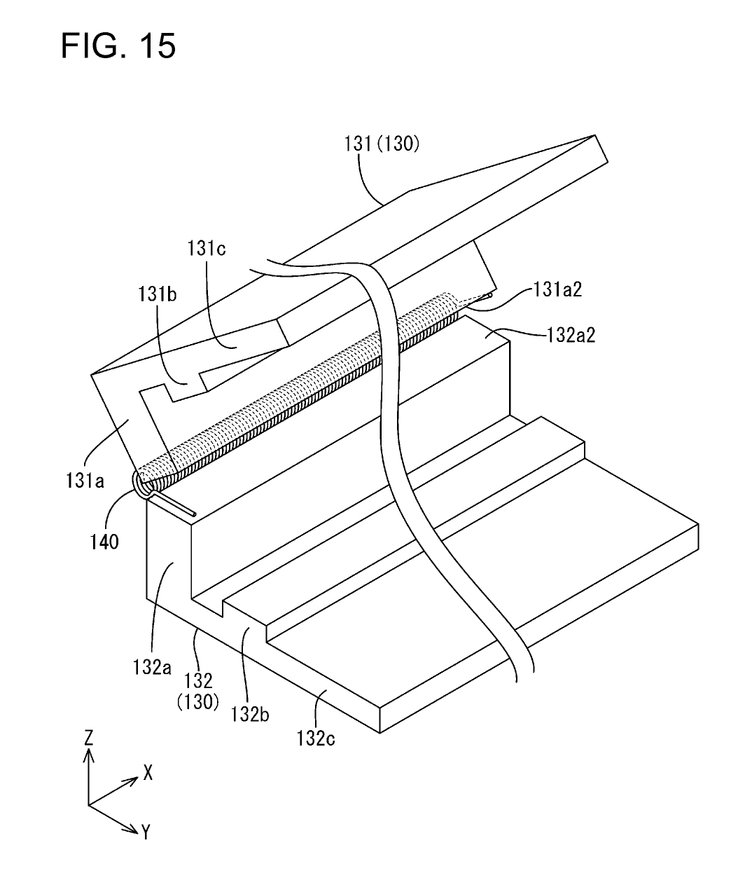

As shown in FIGS. 13 and 14, in a liquid crystal display device 110 according to Embodiment 2, a front side member 131 and a back side member 132 constituting the clamping member 130 are each actuated by a helical spring (a spring member example) 140. The helical spring 140 is disposed between the front side member 131 and the back side member 132, connecting both members. More precisely, the helical spring 140 is a boundary between the front side member 131 and the back side member 132, and is disposed on the external side of the main sections 131a and 132b (on the side opposite to the side that abuts the LED substrate 118). Each end of the helical spring 140 is respectively attached to a surface 131a2 of the front side main section 131a, which has a surface 131a2 facing the back side main section 132a, and to a surface 132a2 of the back side main section 132a, which has a surface 132a2 facing the front side main section 131a (see FIG. 15). According to such a configuration, the clamping member 130 can be divided into two: the front side member 131 and the back side member 132, while these members still stay connected to each other by the helical spring 140. Consequently, in the manufacturing process of the liquid crystal display device 110, the front side member 131 and the back side member 132 can easily be engaged and disengaged.

Also, in Embodiment 2, the leading edge surface of the support rib 113c provided on the frame 113 meets the surface of the front side member 131 of the clamping member 130 that faces the frame 113, in the direction of its height (Z axis direction). And, at the site on the front side member 131 of the clamping member 130 that faces the support rib 113c, a fitting protrusion 131a1 protruding toward the support rib 113c is provided (see FIG. 13). On the other hand, at the site on the leading edge surface of the support rib 113c that faces the fitting protrusion 131a1, a fitting recess (not shown) of a concave shape that opens toward the fitting protrusion 131a1 and that can engage the fitting protrusion 131a1 is provided. The fitting protrusion 131a1 provided on the clamping member 130 is configured to engage the fitting recess provided on the leading edge surface of the support rib 113c. Consequently, the clamping member 130 is supported against the frame 113. Also, because the fitting protrusion 131a1 engages the fitting recess of the support rib 113c, the clamping member 130 is aligned against the frame 113 in the long side direction (X axis direction) and in the short side direction of the clamping member 130 (Y axis direction).

### Modification Example of Embodiment 2

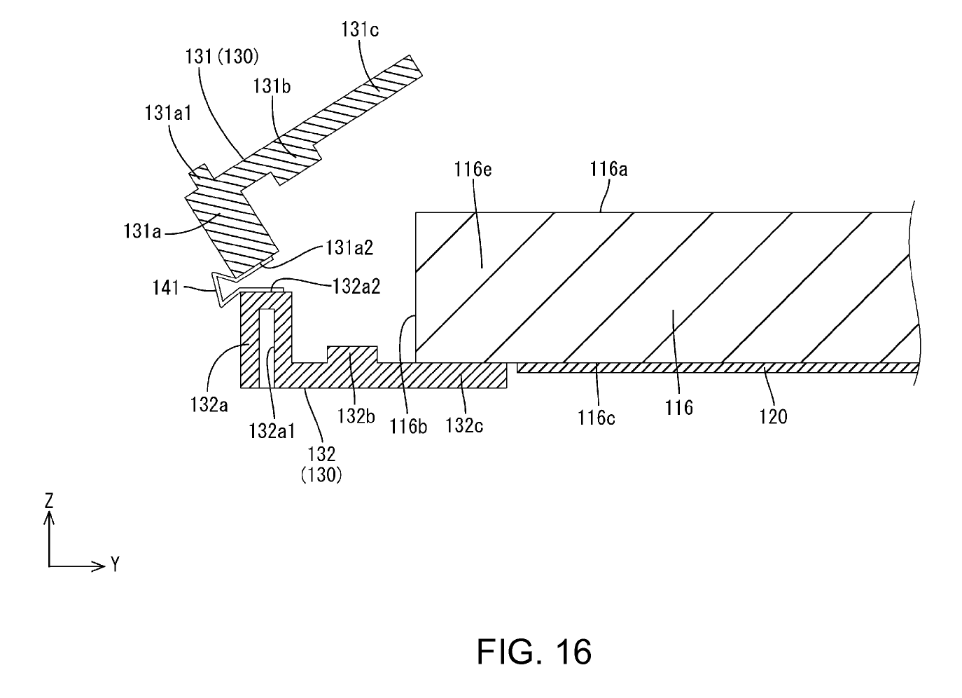

Next, a modification example of Embodiment 2 is described. A liquid crystal display device 110 according to the modification example has a spring member that connects the front side member 131 and the back side member 132, and that has a configuration different from the configuration of the spring member of Embodiment 2. Other aspects of the configuration are similar to Embodiment 2, and therefore descriptions of the structure, functions, and effects are omitted. As shown in FIG. 16, in the modification example of Embodiment 2, the front side member 131 and the back side member 132 are connected not by a helical spring 140, but by a plate spring 141. In this configuration also, the clamping member 130 can be divided into two: the front side member 131 and the back side member 132, while these members still stay connected to each other by the plate spring 141. Therefore, the front side member 131 and the back side member 132 can easily be engaged and disengaged in the manufacturing process of the liquid crystal display device 110.

### Embodiment 3

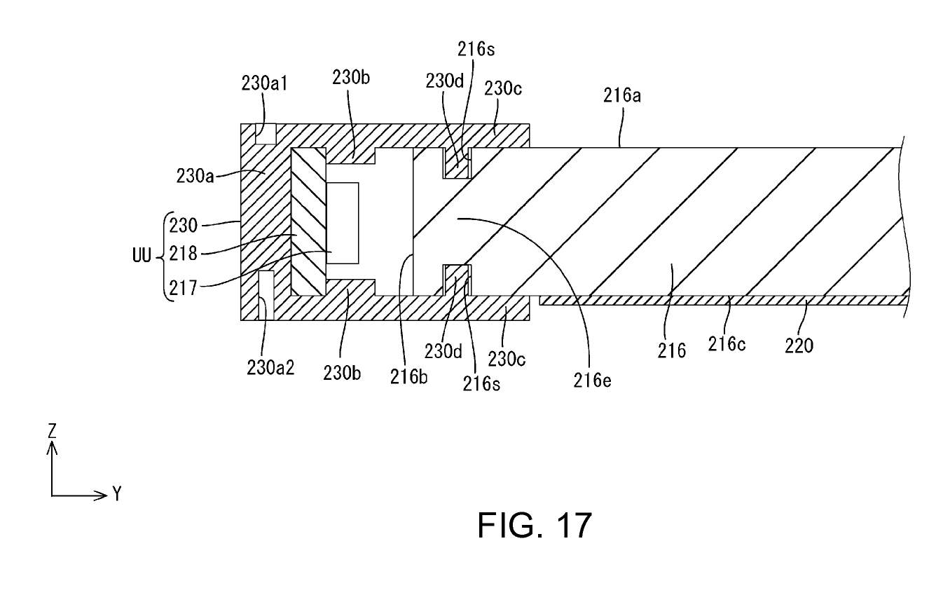

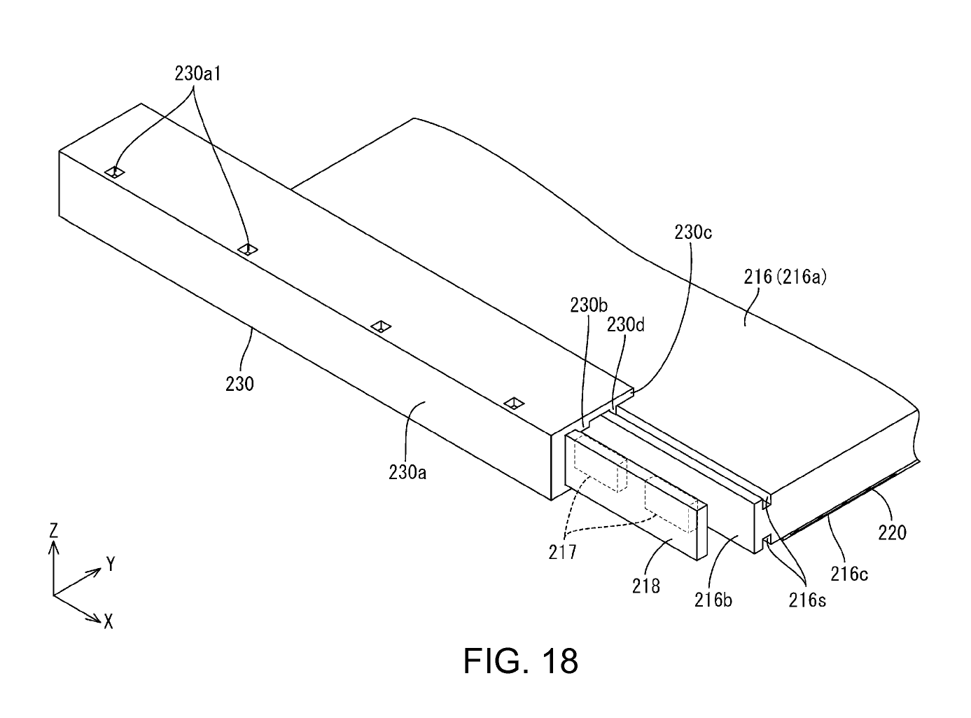

Embodiment 3 is described with reference to figures. In Embodiment 3, the configuration of the clamping member 230 and the form of assembling the clamping member 230 to the light guide plate 216 is different from Embodiment 1. Other aspects of the configuration are similar to Embodiment 1, and therefore descriptions of the structure, functions, and effects are omitted. In FIGS. 17 and 18, sites whose reference characters are those used for the corresponding sites of Embodiment 1 plus 200 are identical to the sites described in Embodiment 1.

As shown in FIGS. 17 and 18, a liquid crystal display device according to Embodiment 3 is configured such that the clamping member 230 cannot be divided into a plurality of members. That is, the entire clamping member 230 is formed as a single piece. On the extension sections 231c and 232c constituting the clamping member 230, at each location respectively facing the light exiting surface 216a and the reverse surface 216c of the light guide plate 216 (locations at which the light guide plate 216 is held), a protrusion 230d that protrudes toward the light guide plate 216 and extends along the direction of long side of the extension sections 231c and 232c (direction of long side of the light receiving face 216b, X axis direction) is provided. Also, on the light exiting surface 216a and the reverse surface 216c of the light guide plate 216, at each of the locations opposing the protrusion 230d described above, a groove section 216s that can engage the protrusion 230d, that has a shape of a groove extending along the direction in which the protrusion 230d extends (direction of long side of the light receiving face 216b, direction of X axis), and that has openings at both ends located apart in the direction of long side of the light receiving face 216b (direction of X axis) is provided.

According to the configuration described above, when the clamping member 230 and the light guide plate 216 are assembled in a manufacturing process for a liquid crystal display device according to the present embodiment, the protrusion 230d of the clamping member 230 can engage the groove section 216s of the light guide plate 216, through the openings provided on both ends of the groove section 216s. In this state, by sliding the light guide plate 216 along the direction in which the protrusion 230d extends (X axis direction), or by sliding the clamping member 230 along the direction in which the groove section 216s extends (X axis direction), the clamping member 230 can easily be installed to the light guide plate 216 (see FIG. 18). Also, when a liquid crystal display device according to the present embodiment is used for a small (40″, for example) television receiver TV, if the clamping member 230 is divisible, individual parts constituting the clamping member 230 are destined to be very small. This can make it difficult to assemble the clamping member 230 in the manufacturing process. In contrast, if the liquid crystal display device according to the present embodiment is used, because the entire clamping member 230 is formed as one piece, the clamping member 230 can be assembled efficiently in a manufacturing process for a television receiver TV.

Modification examples of embodiments described above are listed below.

(1) In the descriptions of embodiments above, embodiments where the clamping member is constituted of a main section, an extension section, and a projection (protrusion) are presented only as examples. The clamping member only needs to be able to align the light guide plate by sandwiching the periphery of the light guide plate, the periphery being located beside the light receiving face, and thereby to be supported against the frame. The configuration of the clamping member is, therefore, not limited.

(2) In the descriptions of embodiments above, embodiments where an LED substrate is held by being sandwiched between the main section and the projection of the clamping member are provided only as an example. The configuration for holding the LED substrate against the clamping member is not limited. For example, LED substrate may be held by being attached to the clamping member with screws.

(3) In the descriptions of embodiments above, the length of the extension section constituting the clamping member, the length being in the direction of short side of the extension section, is not limited. However, the length is preferably long enough to maintain the state in which the periphery of the light guide plate, the periphery being located beside the light receiving face, can be sandwiched between the extension sections even if the light guide plate shrinks due to causes such as cooling. According to such a configuration, even if the light guide plate shrinks due to cooling or other causes, the clamping member and the light guide plate can be made hard to be disengaged.

(4) In the descriptions of Embodiment 1 and Embodiment 3 above, configurations where the clamping member is supported against the frame by the engagement between the fitting recesses provided on the clamping member and the support ribs provided on the frame are presented only as an example. The configuration in which the clamping member is supported against the frame is not limited.

(5) In the descriptions of embodiments above, configurations in which the clamping member is supported against the chassis by being attached to the chassis with screws are presented only as an example. The configuration in which the clamping member is supported against the chassis is not limited.

(6) In the description of Embodiment 2 above, the configuration in which a locking piece is provided on one divided member constituting the clamping member, and a locking hole is provided on the other divided member is presented only as an example. The configuration for assembling the divided members and the form of assembling the divided members are not limited.

(7) Besides the embodiments described above, the configuration, shape, arrangement, and the like of the clamping member can be modified as appropriate.

(8) Besides Embodiment 2 described above, the form of dividing the clamping member can be modified as appropriate.

(9) In the descriptions of the embodiments above, a liquid crystal display device where a liquid crystal panel is used as the display panel is presented only as an example. The present invention can also be applied to display devices where other types of display panels are used.

Embodiments of the present invention are described in detail above. However, these are only examples and the scope of the present invention is not limited to them. Technologies presented in claims include various transformations and modifications of specific examples described above.

Additionally, technology components described in this specification and in appended figures provide technical utility independently or in combination with other components, and are not limited to combinations stated in claims at the time of application filing. Furthermore, with technologies described as examples in this specification and in appended figures, multiple objectives can simultaneously be achieved. Those technologies are deemed to have technical utility by achieving one of those objectives.

### DESCRIPTION OF REFERENCE CHARACTERS

TV television receiver
LDU liquid crystal display unit
PWB power supply substrate
MB main substrate
CTB control substrate
CV cover member
ST stand
UU unified unit
10, 110 liquid crystal display device
11, 111 liquid crystal panel
12, 112 backlight device
13, 113 frame
14, 114 chassis
15, 115 optical member
16, 116, 216 light guide plate
16b, 116b, 216b light receiving face
17, 117, 217 LED
18, 118, 218 LED substrate
20, 120, 220 reflective sheet
13c, 113c support rib
30, 130, 230 clamping member
31, 131 front side member
32, 132 back side member

1. A display device, comprising:
a light source;
a light source substrate having said light source on one surface thereof;
a display panel that uses light from said light source to perform display;
a light guide plate having as a light exiting surface, an opposite surface that is opposite to said light exiting surface, and at least one light receiving face on a side, said light guide plate being disposed such that the light exiting surface faces a side of the display panel opposite to a display surface thereof and such that the light receiving face faces the light source so as to guide light from the light source towards the display panel;
a chassis disposed behind of the light guide plate;
a frame disposed on a front side of said display panel and sandwiching, together with the chassis, at least the display panel, the light source, and the light guide plate therebetween; and
a clamping member that holds the light source substrate, clamps an edge of the light guide plate adjacent to the light receiving face thereof, and covers at least a display panel of the light source, said clamping member being supported by at least the frame so as to fix a position of the light guide plate with respect to the frame.

2. The display device according to claim 1, wherein said clamping member is divided into two members in a thickness direction of said light guide plate, said clamping member being constituted of a frame-side member facing the frame and a chassis-side member facing the chassis.

3. The display device according to claim 2, further comprising:
a locking piece disposed on either one of said frame-side member or said chassis-side member and protruding towards the other of said frame-side member or said chassis-side member; and
a locking hole in said other of the frame-side member or the chassis-side member at a location facing the engaging piece, said locking hole opening towards said locking piece,
wherein the locking piece engages the locking hole.

4. The display device according to claim 2,
wherein the light receiving face has a rectangular shape with a short side direction thereof being the thickness direction of the light guide plate, and
wherein the clamping member is further divided along a long side direction of the light receiving face.

5. The display device according to claim 2, further comprising:
a spring member at a connecting point of the frame-side member and the chassis-side member, said spring member respectively actuating the frame-side member and the chassis-side member.

6. The display device according to claim 1,
wherein the light receiving face has a rectangular shape with a short side direction thereof being a thickness direction of the light guide plate,
wherein protrusions that protrude towards the light guide plate are provided on the clamping member at respective locations where the light guide plate is clamped, said protrusions extending along a long side direction of the light receiving face, and
wherein grooves are provided in the light receiving face of the light guide plate on both long side directions thereof and have a trench-like shape along said long side directions, said grooves being provided in the light guide plate at locations facing the corresponding protrusions and engaging said protrusions.

7. The display device according to claim 1, further comprising:
a buffer member between the clamping member and the light guide plate at a location where the light guide plate is clamped, said buffer member being softer than said clamping member.

8. The display device according to claim 1, wherein the clamping member is secured to the chassis with screws.

9. The display device according to claim 1,
wherein the clamping member is a metal having a thermal conductivity that is at least the same as that of the chassis, and
wherein the clamping member includes a portion covering a chassis side of the light source, said portion abutting the chassis.

10. The display device according to claim 1, further comprising:
a support rib provided on the frame at a location exposed to the clamping member, said support rib extending towards said clamping member,
wherein a fitting recess is provided in the clamping member at a location facing said support rib, said fitting recess engaging said support rib.

11. The display device according to claim 10, wherein said support ribs are provided along the edge of the light exiting surface on a light receiving face side with gaps therebetween.

12. The display device according to claim 11,
wherein the clamping member has a projection that protrudes toward the light source at a location exposed to said light source and an abutting surface that abuts a surface of the light source substrate opposite to the one surface on which the light source is disposed, and
wherein the light source substrate is held by being clamped by said projection and said abutting surface in a thickness direction of the light source substrate.

13. The display device according to claim 11, wherein a portion of said projection opposite to a side abutting the light source substrate is located closer to the light receiving face than a light emitting surface of the light source.

14. The display device according to claim 1, wherein said display panel is a liquid crystal panel using liquid crystal.

15. A television receiver, comprising: the display device according to claim 1.
